(19) United States
(12) Patent Application Publication
(10) Pub. No.: US 2015/0105261 A1
(43) Pub. Date: Apr. 16, 2015

(54) OXIDE SUPERCONDUCTING THIN FILM AND METHOD OF MANUFACTURING THE SAME

(71) Applicants: Tatsuoki Nagaishi, Osaka-shi (JP); Genki Honda, Osaka-shi (JP); Iwao Yamaguchi, Tsukuba-shi (JP); Takaaki Manabe, Tsukuba-shi (JP); Takeshi Hikata, Tsukuba-shi (JP); Hiroaki Matsui, Tsukuba-shi (JP); Wakichi Kondo, Tsukuba-shi (JP); Hirofumi Yamasaki, Tsukuba-shi (JP); Toshiya Kumagai, Tsukuba-shi (JP)

(72) Inventors: Tatsuoki Nagaishi, Osaka-shi (JP); Genki Honda, Osaka-shi (JP); Iwao Yamaguchi, Tsukuba-shi (JP); Takaaki Manabe, Tsukuba-shi (JP); Takeshi Hikata, Tsukuba-shi (JP); Hiroaki Matsui, Tsukuba-shi (JP); Wakichi Kondo, Tsukuba-shi (JP); Hirofumi Yamasaki, Tsukuba-shi (JP); Toshiya Kumagai, Tsukuba-shi (JP)

(73) Assignee: SUMITOMO ELECTRIC INDUSTRIES, LTD., Osaka-shi, Osaka (JP)

(21) Appl. No.: 14/403,706

(22) PCT Filed: May 31, 2012
(86) PCT No.: PCT/JP2012/064099

§ 371 Date: Nov. 25, 2014

(51) Int. Cl. H01B 12/06; H01B 13/30

(52) U.S. Cl. CPC H01B 12/06; H01B 13/30
USPC 505/124; 505/100; 505/470; 427/62; 252/520.3; 252/520.5

(57) ABSTRACT

An oxide superconducting thin film wherein nanoparticles functioning as flux pins are dispersed in the film is provided. The oxide superconducting thin film wherein the nanoparticles in the oxide superconducting thin film have a dispersing density of 10²⁰ particles/m³ to 10²⁴ particles/m³ is provided. The oxide superconducting thin film wherein the nanoparticles have a particle diameter of 5 nm to 100 nm is provided. A method of manufacturing an oxide superconducting thin film wherein a predetermined amount of a solution obtained by dissolving nanoparticles functioning as flux pins in a solvent is added to a solution obtained by dissolving an organometallic compound in a solvent to prepare a source material solution for an oxide superconducting thin film, and the source material solution is used to manufacture the oxide superconducting thin film through a coating-pyrolysis process is provided.

### TECHNICAL FIELD

The present invention relates to an oxide superconducting thin film having a high critical current value Ic, and a method of manufacturing the oxide superconducting thin film.

### BACKGROUND ART

High-temperature superconducting wires aimed at application to electric power equipment, such as a cable, a current limiter, and a magnet, are being actively developed since discovery of a high-temperature superconductor having superconductivity at the temperature of liquid nitrogen. Among them, an oxide superconducting thin film wire obtained by forming an oxide superconducting thin film on a substrate is attracting attention.

One of methods of fabricating the oxide superconductors is a coating-pyrolysis process (Metal Organic Deposition, abbreviated to MOD process) (see, e.g., Japanese Patent Laying-Open No. 2007-165153 (PTD 1).

This process involves applying to a substrate a source material solution (MOD solution) manufactured by dissolving respective organometallic compounds of RE (rare earth element), such as Y (yttrium), Ba (barium) and Cu (copper) in a solvent to form a coated film, and then performing a calcining heat treatment around 500° C., for example, to thermally decompose the organometallic compounds. Thermally decomposed organic constituents are removed, thereby producing a calcined film which is a precursor of an oxide superconducting thin film. Then, the manufactured calcined film is subjected to a sintering heat treatment at a still higher temperature (e.g., around 750° C. to 800° C.) for crystallization, thereby manufacturing a layer of superconducting thin film expressed by REBa₂Cu₃O₇₋ₓ. This process is widely used because of its characteristics such as requiring simple production equipment as compared with vapor phase methods by which manufacturing is mainly performed in a vacuum (such as vapor deposition, sputtering, and pulsed laser vapor deposition) and easily adapting to a large area or a complicated shape.

The MOD process includes a TFA-MOD process (Metal Organic Deposition using TriFluoroAcetates) in which an organometallic compound containing fluoride is used as a source material solution and a fluorine-free MOD process in which a fluorine-free organometallic compound is used as a source material.

By means of the TFA-MOD process, an oxide superconducting thin film having a favorable in-plane orientation can be obtained. However, by this process, BaF₂ (barium fluoride) which is a fluoride is produced at the time of calcining, and this BaF₂ is pyrolized at the time of sintering to generate a dangerous hydrogen fluoride gas. Therefore, an apparatus or facility for processing the hydrogen fluoride gas is necessary.

In contrast, the FF-MOD process is advantageous in that a dangerous gas such as a hydrogen fluoride gas is not produced, which is environmentally friendly and requires no processing facility.

In such a FF-MOD process, in order to obtain an oxide superconducting thin film having a higher critical current value Ic, stacking oxide superconducting thin film layers produced by repeating the above-described application of a source material solution, a calcining heat treatment and a sintering heat treatment, thereby increasing the film thickness.

However, when a Y123 oxide superconducting thin film is manufactured, for example, with the conventional FF-MOD process, a problem arises in that Ic does not become sufficiently high even if the film thickness is increased, due to a low superconducting critical current density Jc.

### CITATION LIST

### Patent Document

### PTD 1: Japanese Patent Laying-Open No. 2007-165153

### SUMMARY OF INVENTION

### Technical Problem

The present invention has an object to provide a thick oxide superconducting thin film manufactured with the FF-MOD process, in which sufficiently high Ic can be obtained, and a method of manufacturing the oxide superconducting thin film.

### Solution to Problem

The inventors of the present application investigated the cause for which Ic does not become sufficiently high with the conventional FF-MOD process even by laminating oxide superconducting layers to increase the film thickness, and obtained the following findings.

Specifically, in the conventional manufacturing method, applying a MOD solution, performing a calcining heat treatment and performing a sintering heat treatment are repeated on a substrate as described above to stack oxide superconducting layers, thereby increasing the film thickness. However, because this oxide superconducting layer has high crystallinity, defects or heterogeneous phases functioning as flux pins (pinning points) to greatly influence improvement in Jc and Ic are hardly formed, so that pinning points are insufficient for the whole thick oxide superconducting thin film.

For this reason, it has been revealed that the pinning effect was not fully exhibited in a thick oxide superconducting thin film manufactured with the conventional manufacturing method, so that Jc and Ic could not be fully improved.

Therefore, the inventors of the present application wholeheartedly investigated a method of forming flux pins dispersed appropriately within a thick oxide superconducting thin film.

Methods of forming the above-described flux pins include a method of forming defects such as stacking faults or foreign substances to obtain flux pins during stacking of oxide superconducting layers, however, this is not technically easy because in the FF-MOD process, oxide superconducting layers are grown in a thermal equilibrium state and regularly stacked from the substrate side.

Therefore, the inventors of the present application conducted experiments supposing that, by introducing nanoparticles, particularly nanoparticles on the order of several tens of nanometers and dispersing them appropriately during manufacture of a thick oxide superconducting thin film, these nanoparticles could fully function as flux pins within stacked oxide superconducting layers to improve Jc and Ic, and confirmed that an oxide superconducting thin film with improved Jc and Ic could be obtained by dispersing nanoparticles.

As a specific method of manufacturing such an oxide superconducting thin film, a solution of nanoparticles on the order of several tens of nanometers is added to an FF-MOD solution which is a source material solution, and using this as a source material solution, application thereof, a calcining heat treatment and a sintering heat treatment are performed similarly to the usual FF-MOD process, so that nanoparticles can be dispersed in a thickened oxide superconducting thin film.

Then, by adjusting the amount of nanoparticles appropriately, pinning points corresponding to a service temperature, for example, corresponding to 77K can be provided.

Then, further investigation has revealed that improvement in Se and Ic achieved by the addition of such nanoparticles is effective not only for the above-described FF-MOD process but also for the TFA-MOD process.

The present invention is based on the above-described findings, and an oxide superconducting thin film of the present invention is an oxide superconducting thin film characterized in that nanoparticles functioning as flux pins are dispersed in the film.

With the oxide superconducting thin film of the present invention, high Ic can be obtained by the pinning effect of nanoparticles, as described above.

A material for forming nanoparticles functioning as such pinning points are not only the nanoparticles functioning as flux pins by themselves, but may also be nanoparticles which react with organometallic compounds contained in a source material solution during a sintering heat treatment to generate a pin compound which functions as flux pins.

As the former nanoparticles, nanoparticles of Ag (silver), Pt (platinum), Au (gold), BaCeO₃ (barium cerate), BaTiO₃ (barium titanate), BaZrO₃ (barium zirconate), SrTiO₃ (strontium titanate), or the like are preferable, but any material can be used without limitation as long as it does not have an adverse influence on the superconducting characteristics of the oxide superconducting thin film.

These nanoparticles are nanoparticles which do not react with a source material solution. Therefore, flux pins can be introduced without performing a heat treatment separately. Moreover, the particulate size of flux pins can be controlled easily, accurately and suitably because the size of flux pins introduced follows the size of added nanoparticles. Furthermore, an oxide superconducting thin layer with high Jc and Ic as desired can be obtained because composition shift will not occur when forming an oxide superconductor.

Among the above-described respective nanoparticles, high-melting point nanoparticles such as Pt, for example, are more preferable because they are restrained from moving to coagulate or deform in the calcining heat treatment and the sintering heat treatment for forming an oxide superconductor.

As the latter nanoparticles, nanoparticles of CeO₂ (cerium oxide), ZrO₂ (zirconium dioxide), SiC (silicon carbide), TiN (titanium nitride), or the like, are preferable, for example. These nanoparticles react with organometallic compounds contained in a source material solution to produce nanoparticles of BaCeO₃ (barium cerate), BaZrO₃ (barium zirconate), Y₂Si₂O₇, and BaTiO₃ (barium titanate), respectively, to function as flux pins.

Because these nanoparticles produce flux pins by reacting with organometallic compounds contained in a source material solution, there is a possibility that composition shift may occur when forming an oxide superconductor unlike the case of the above-described nanoparticles which do not react with a source material solution. It is preferable to previously prepare the source material solution taking into account that possibility.

Although a Y123 oxide superconducting thin film is particularly preferable as an oxide superconducting thin film, another rare earth element may be used instead of Y.

It is noted that although the document “Preparation of Superconducting Ba₂YCu₃O_{7-y}/Ag Composite Films by the Dipping-Pyrolysis Using Metal Naphthenates at 750° C. (T. Kumagai et al., JJAP, Vol. 30 (1991), No. 7B, pp. L1268-L1270)” indicates a Ba₂YCu₃O_{7-y}/Ag composite film, production of this composite film is not aimed at formation of flux pins. That is, it is intended to produce a Ba₂YCu₃O_{7-y}/Ag composite film through use of a source material solution prepared by dissolving into toluene Ag naphthenate in addition to naphthenates of Y, Ba and Cu, to thereby locate ionized Ag as atoms in an oxide superconducting thin film to achieve improvement in characteristics because of the proximity effect and relief of stress. It is not intended to form flux pins as in the present invention, nor is it intended to introduce Ag in the form of nanoparticles.

Preferably, the above-described oxide superconducting thin film is an oxide superconducting thin film characterized in that the oxide superconducting thin film is an oxide superconducting thin film manufactured through a coating-pyrolysis process.

The above-described invention exerts prominent effects particularly in the oxide superconducting thin film manufactured through the coating-pyrolysis process.

Preferably, the above-described oxide superconducting thin film is an oxide superconducting thin film characterized in that the nanoparticles in the oxide superconducting thin film have a dispersing density of 10²⁰ particles/m³ to 10²⁴ particles/m³.

If the dispersing density of nanoparticles is excessively low, the pinning effect cannot be fully be exerted. On the other hand, if the dispersing density is excessively high, the flow of a superconducting current may be blocked to decrease Ic.

When the dispersed density is 10²⁰ particles/m³ to 10²⁴ particles/m³, these problems does not occur. It is noted that the dispersing density can be adjusted by adjusting the amount of nanoparticle solution added to the above-described source material solution.

Preferably, the above-described oxide superconducting thin film is an oxide superconducting thin film characterized in that the nanoparticles have a particle diameter of 5 nm to 100 nm.

If the particle diameter of nanoparticles is excessively small, the pinning effect around 77K cannot be fully be exerted. On the other hand, if the particle diameter is excessively large, the pinning effect will be reduced.

The particle diameter of 5 nm to 100 nm is a size corresponding to coherence length, which cannot raise these problems.

Preferably, the above-described oxide superconducting thin film is an oxide superconducting thin film characterized in that the nanoparticles are nanoparticles which do not react with an organometallic compound material which is a source material of the oxide superconducting thin film.

As described above, by using the nanoparticles which do not react with the organometallic compound in the source material solution, an oxide superconducting thin film with high Ic as desired can be obtained without causing composition shift and the like when forming the oxide superconducting thin film.

Preferably, the above-described oxide superconducting thin film is an oxide superconducting thin film characterized in that the nanoparticles contain at least one type of Ag (silver), Pt (platinum), Au (gold), BaCeO₃ (barium cerate), BaTiO₃ (barium titanate), BaZrO₃ (barium zirconate), and SrTiO₃ (strontium titanate).

As described above, as nanoparticles functioning as flux pins by themselves, nanoparticles of Ag, Au, Pt, BaCeO₃, BaTiO₃, BaZrO₃, and SrTiO₃ are effective.

Preferably, the above-described oxide superconducting thin film is an oxide superconducting thin film characterized in that the nanoparticles are nanoparticles generated by using and causing a material which reacts with an organometallic compound to generate nanoparticles to react with the organometallic compound.

As described above, the investigation conducted by the inventors of the present application has revealed that, by adopting the method of adding a solution of a material which reacts with an organometallic compound to produce nanoparticles to a source material solution without using nanoparticles which do not react with organometallic compounds, such as Ag, nanoparticles produced by reaction with the organometallic compound similarly function as flux pins when forming an oxide superconducting thin film.

Since nanoparticles are produced when forming the oxide superconducting thin film, nanoparticles are dispersed uniformly in the oxide superconducting thin film. Thus, an oxide superconducting thin film of more stable quality can be obtained.

Preferably, the above-described oxide superconducting thin film is an oxide superconducting thin film characterized in that the nanoparticles are nanoparticle formed by reaction between nanoparticles of at least one type of CeO₂ (cerium oxide), ZrO₂ (zirconium dioxide), SiC (silicon carbide), and TiN (titanium nitride) and an organometallic compound contained in a source material solution.

As described above, as nanoparticles which react with an organometallic compound contained in the source material solution at the time of sintering heat treatment to produce a pin compound functioning as flux pins, CeO₂, ZrO₂, SiC, and TiN are effective, and nanoparticles of BaCeO₃, BaZrO₃, Y₂Si₂O₇, and BaTiO₃ are produced, respectively, and function as flux pins.

A method of manufacturing an oxide superconducting thin film of one aspect of the present invention is a method of manufacturing an oxide superconducting thin film, characterized in that a predetermined amount of a solution obtained by dissolving nanoparticles functioning as flux pins in a solvent is added to a solution obtained by dissolving an organometallic compound in a solvent to prepare a source material solution for an oxide superconducting thin film, and the source material solution is used to manufacture an oxide superconducting thin film through a coating-pyrolysis process.

By preparing a solution of nanoparticles separately from preparation of a solution (MOD solution) obtained by dissolving an organometallic compound in a solvent, and then adding the solution of nanoparticles to the MOD solution, a source material solution with the nanoparticles dispersed therein appropriately can be prepared.

Then, through use of this source material solution, by performing application thereof, a calcining heat treatment and a sintering heat treatment to manufacture an oxide superconducting thin film through a coating-pyrolysis process, an oxide superconducting thin film with high Ic in which nanoparticles functioning as flux pins are dispersed appropriately can be obtained.

It is noted that the amount of addition of the solution of nanoparticles to the MOD solution is determined appropriately depending on the type and thickness of oxide superconducting thin film, as well as a coating-pyrolysis process adopted.

A method of manufacturing an oxide superconducting thin film of another aspect of the present invention is a method of manufacturing an oxide superconducting thin film, characterized in that a predetermined amount of a solution obtained by dissolving nanoparticles reacting with an organometallic compound to generate nanoparticles functioning as flux pins in a solvent is added to a solution obtained by dissolving an organometallic compound in a solvent to prepare a source material solution for an oxide superconducting thin film, and the source material solution is used to manufacture an oxide superconducting thin film through a coating-pyrolysis process.

Through use of a source material solution obtained by adding to a MOD solution a solution of nanoparticles which react with an organometallic compound to produce nanoparticles functioning as flux pins, by performing application thereof, calcining and sintering through a coating-pyrolysis process, nanoparticles functioning as flux pins by reaction with an organometallic compound are produced when forming an oxide superconducting thin film and are dispersed in the film. Thus, an oxide superconducting thin film with high Jc can be manufactured.

Preferably, the above-described method of manufacturing an oxide superconducting thin film is a method of manufacturing an oxide superconducting thin film characterized in that a dispersing agent is added to one of the solution obtained by dissolving nanoparticles functioning as flux pins in a solvent and the solution obtained by dissolving nanoparticles reacting with the organometallic compound to generate nanoparticles functioning as flux pins in a solvent.

Since nanoparticles in a solution are likely to coagulate in the solution, a solution with nanoparticles dispersed therein more uniformly can be prepared by adding a dispersing agent to restrain occurrence of coagulation.

Preferably, the above-described method of manufacturing an oxide superconducting thin film is a method of manufacturing an oxide superconducting thin film characterized in that the solution is prepared taking into account the amount of organometallic compound to be consumed by reaction with the nanoparticles reacting with the organometallic compound to generate nanoparticles functioning as flux pins.

When a solution of nanoparticles which react with an organometallic compound to produce nanoparticles functioning as flux pins is used as the solution to be added to the MOD solution, the organometallic compound related to the reaction is consumed as flux pins are produced. Therefore, composition shift and the like may occur in an oxide superconducting thin film as described above.

Therefore, by preparing a MOD solution having a composition with consumption of this organometallic compound previously taken into account, a desired oxide superconducting thin film can be obtained with composition shift and the like restrained from occurring.

### Advantageous Effects of Invention

According to the present invention, an oxide superconducting thin film in which sufficiently high Ic can be obtained, and a method of manufacturing the oxide superconducting thin film can be provided.

### BRIEF DESCRIPTION OF DRAWINGS

FIG. 1 is a cross-sectional view schematically showing a Y123 oxide superconducting thin film formed on a substrate in an example.

FIG. 2 is a cross-sectional view schematically showing a substrate in an example.

FIG. 3 is a cross-sectional view schematically showing a Y:123 oxide superconducting thin film formed on a substrate in a comparative example.

### DESCRIPTION OF EMBODIMENTS

Hereinafter, the present invention will be described based on embodiments.

The present invention will be described more specifically citing examples in which Y123 oxide superconducting thin films were formed through the FF-MOD process.

### EXAMPLES

### 1. Structure of Y123 Oxide Superconducting Thin Film

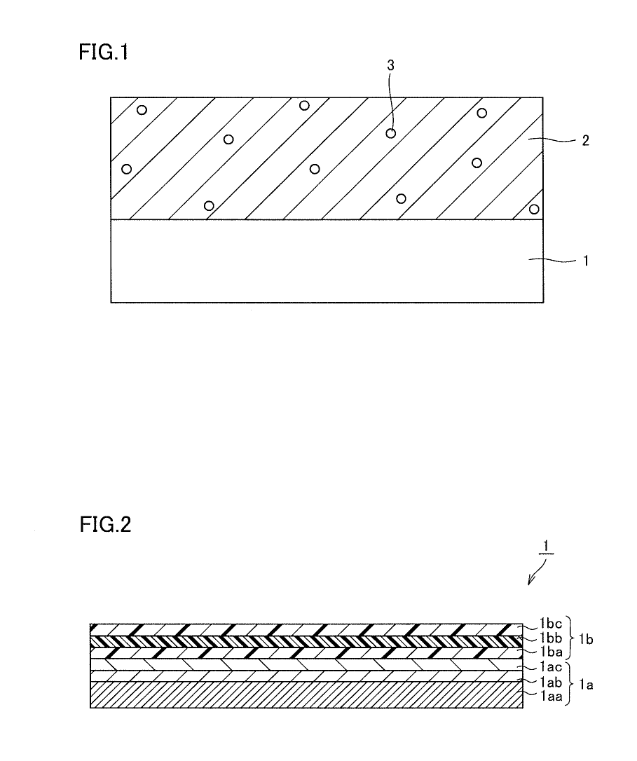

FIG. 1 is a cross-sectional view schematically showing a superconducting thin film formed on a substrate 1 in an example. As shown in FIG. 1, nanoparticles 3 are dispersed in a Y123 oxide superconducting thin film 2 in the present example.

### 2. Formation of Y123 Oxide Superconducting Thin Film

### Example 1

In the present example, a source material solution was produced through use of Pt nanoparticles as nanoparticles, and further, this source material solution was used to form a Y123 oxide superconducting thin film.

(1) Production of Source Material Solution

(a) Production of MOD Solution

Respective acetylacetonate complexes of Y, Ba and Cu were prepared such that a molar ratio of Y:Ba:Cu was 1:2:3 and dissolving them in alcohol to produce an alcohol solution of organometallic compound.

(b) Pt Nanoparticle-Dispersed Solution

A platinum nanocolloid solution (particle diameter: 10 nm; Pt concentration: 1 wt %; solvent: ethanol; a dispersing agent does not contain any elements other than C, H, O, and N) was used.

(c) Production of Source Material Solution

The produced alcohol solution of organometallic compound and the Pt nanoparticle-dispersed solution were mixed such that the dispersing density of Pt nanoparticles was 10²³ particles/m³, thereby producing a source material solution.

(2) Production of Y123 Oxide Superconducting Thin Film

(a) Calcining Heat Treatment Step

In a calcined-film forming step, a three-layer type calcined film was produced.

As a substrate, substrate 1 was prepared in which an intermediate layer 1b including three layers of a CeO₂ layer 1ba, a YSZ layer 1bb and a CeO₂ layer 1bc was provided on a cladding substrate 1a having a Cu layer lab and an Ni layer 1ac formed on SUS 1aa as shown in FIG. 2. The above-described source material solution was applied on substrate 1 to produce a coated film. Next, the produced coated film was raised in temperature at a temperature rise speed of 20° C./min up to 500° C. under an atmospheric air and then held for 2 hours. The film was thereafter cooled in a furnace to produce a 150-nm-thick calcined film of a first layer.

Calcined films of a second layer and a third layer were produced under the same conditions as the first layer.

(b) Sintering Heat Treatment Step

A sintering heat treatment was performed by raising in temperature the obtained three-layer type calcined films at a temperature rise speed of 50° C./min up to 780° C. under an argon/oxygen mixed gas atmosphere of oxygen concentration of 100 ppm and then holding the films for 20 minutes as they were. After termination of the sintering heat treatment, the gas atmosphere was switched to a gas with oxygen concentration 100 vol % when the temperature was lowered to 500° C. for about 3 hours. Cooling in a furnace was further performed down to room temperature for about another 5 hours to produce a Y123 oxide superconducting thin film. Accordingly, 450-nm-thick Y123 oxide superconducting thin film 2 having a dispersing density of nanoparticles 3 of 10²³ particles/m³ was produced as shown in FIG. 1.

### Example 2

A Y123 oxide superconducting thin film was produced under the same conditions as those in Example 1 except that Pt nanoparticles had a particle diameter of 5 nm and the dispersing density was 10²⁴ particles/m³.

### Example 3

A Y123 oxide superconducting thin film was produced under the same conditions as those in Example 1 except that Pt nanoparticles had a particle diameter of 5 nm and the dispersing density was 10²² particles/m³.

### Example 4

A Y123 oxide superconducting thin film was produced under the same conditions as those in Example 1 except that Pt nanoparticles had a particle diameter of 100 nm and the dispersing density was 10²² particles/m³.

### Example 5

A Y123 oxide superconducting thin film was produced under the same conditions as those in Example 1 except that Pt nanoparticles had a particle diameter of 100 nm and the dispersing density was 10²¹ particles/m³.

### Example 6

In the present example, nanoparticles 3 were produced using SiC nanoparticles instead of the Pt nanoparticles of Examples 1 to 5.

(1) Production of Source Material Solution

(a) Production of MOD Solution

First, starting from respective acetylacetonate salts of Y, Ba, and Cu, they were synthesized at a ratio (molar ratio) of Y:Ba:Cu=2:2:3 to produce a MOD solution in which alcohol was used as a solvent. It is noted that the total cation concentration as a total of Y³⁺, Ba²⁺ and Cu²⁺ of the MOD solution was set at 1 mol/L. It is noted that the reason for setting the ratio of Y at 2 was because the reaction of SiC with Y to produce Y₂Si₂O₇ when forming a Y123 oxide superconducting thin film was taken into consideration.

(b) Production of Nanoparticle Solution

In 12 ml of alcohol, 1000 mg of SiC nanoparticles having a particle diameter of 20 nm was dissolved to produce a nanoparticle solution. At this time, 30 mg of dispersing agent was added.

(c) Preparation of Source Material Solution

Into 1 ml of a MOD solution, 30 μl of nanoparticle solution was mixed to prepare a source material solution.

The application, calcining heat treatment step and sintering heat treatment step were performed under the same conditions as those in Example 1 to produce a Y123 oxide superconducting thin film.

Then, it was confirmed that Y₂Si₂O₇ was dispersed in this Y123 oxide superconducting thin film by cross-sectional TEM (Transmission Electron Microscope) observation and composition analysis by EDX (Energy Dispersive X-ray spectroscopy).

### Comparative Example 1

A Y123 oxide superconducting thin film was produced under the same conditions as those in Example 1 except that a nanoparticle solution was not added to a MOD solution.

3. Evaluation of Y123 Oxide Superconducting Thin Film

(1) Superconducting Characteristics

Using the Y123 oxide superconducting thin films obtained in Examples 1 to 6 and Comparative Example 1 with no nanoparticles added, Jc was measured at 77K under a self magnetic field. Test results are shown in Table 1.

TABLE 1

| | Nanoparticle | | | |
|---|---|---|---|---|
| | | Particle | Dispersing | |
| | | Diameter | Density | Jc |
| | Type | (nm) | (particles/m³) | (MA/cm²) |
| Example 1 | Pt | 10 | 10²³ | 3 |
| Example 2 | Pt | 5 | 10²⁴ | 2.1 |
| Example 3 | Pt | 5 | 10²² | 1.4 |
| Example 4 | Pt | 100 | 10²⁰ | 2.3 |
| Example 5 | Pt | 100 | 10²¹ | 1.5 |
| Example 6 | Y₂Si₂O₇ | 20 | 5 × 10²² | 2.8 |
| Comparative | — | — | — | 1 |
| Example 1 | | | | |

(2) Consideration

(a) Examples 1 to 5

As shown in Table 1, the Y123 oxide superconducting thin films of Examples 1 to 5 exhibit high Jc as compared with Comparative Example 1. Accordingly, it could be confirmed that the dispersed nanoparticles were functioning as flux pins.

However, in the case where the particle diameter is small as indicated by Examples 2 and 3, as the dispersing density decreases, the pinning effect is reduced, and Jc is decreased. In the case where the particle diameter is large as indicated in Examples 4 and 5, Jc is decreased as the dispersing density increases, since the path of a superconducting current is blocked. It is therefore seen that the dispersing density of nanoparticles preferably ranges from 10²⁰ particles/m³ to 10²⁴ particles/m³ with respect to the particle diameter of 5 nm to 100 nm which is the particle diameter size corresponding to coherence length.

(b) Example 6

As shown in Table 1, Example 6 indicates high Jc as compared with Comparative Example 1. This indicates that even if a material which reacts with an organometallic compound to produce nanoparticles is used, the nanoparticles (Y₂Si₂O₇) produced by reaction with the organometallic compound similarly function as flux pins.

(c) Comparative Example 1

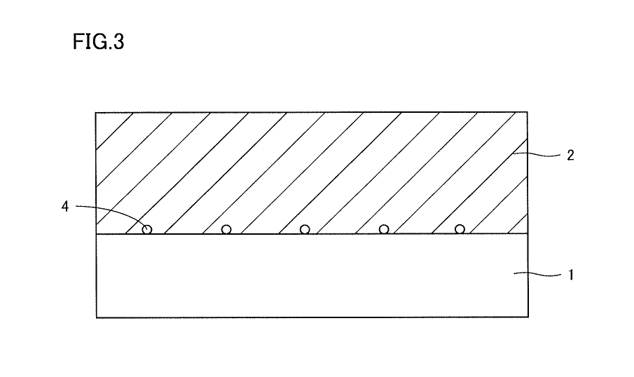

As shown in Table 1, in Comparative Example 1, Jc is small as compared with Examples 1 to 6. This is considered because in Comparative Example 1, CeO₂ of the intermediate layer of substrate 1 reacts with the first layer of Y123 oxide superconducting thin film 2 to form flux pins 4 at a boundary portion as shown in FIG. 3, whereas flux pins are not formed in the films of second and subsequent layers, causing a shortage of pinning points.

From the foregoing, it can be understood that according to the present invention, a Y123 oxide superconducting thin film having high Jc and in turn high Ic can be produced through the MOD process. It is noted that although the above description has addressed the example where the Pt nanoparticles and the SiC nanoparticles were used as nanoparticles, it has been confirmed that nanoparticles of Ag, Au, BaCeO₃, CeO₂, SrTiO₃, ZrO₂, CeO₂, ZrO₂, TiN, and the like also have a similar flux pinning function.

As described above, according to the present invention, an oxide superconducting thin film having higher Jc and Ic can be formed.

Although the present invention has been described based on the embodiments, the present invention is not limited by the above embodiments. Various modifications can be made to the above embodiments within the scope identical and equivalent to the present invention.

### REFERENCE SIGNS LIST

1 substrate; 1a cladding substrate; 1aa SUS; lab Cu layer; 1ac Ni layer; 1b intermediate layer; 1ba, 1bc CeO₂ layer; 1bb YSZ layer; 2 Y123 oxide superconducting thin film; 3 nanoparticle; 4 flux pin.

1. An oxide superconducting thin film characterized in that nanoparticles functioning as flux pins are dispersed in the film.

2. The oxide superconducting thin film according to claim 1, characterized in that said oxide superconducting thin film is an oxide superconducting thin film manufactured through a coating-pyrolysis process.

3. The oxide superconducting thin film according to claim 1, characterized in that said nanoparticles in said oxide superconducting thin film have a dispersing density of 10²⁰ particles/m³ to 10²⁴ particles/m³.

4. The oxide superconducting thin film according to claim 1, characterized in that said nanoparticles have a particle diameter of 5 nm to 100 nm.

5. The oxide superconducting thin film according to claim 1, characterized in that said nanoparticles are nanoparticles which do not react with an organometallic compound material which is a source material of the oxide superconducting thin film.

6. The oxide superconducting thin film according to claim 5, characterized in that said nanoparticles contain at least one type of Ag (silver), Pt (platinum), Au (gold), BaCeO₃ (barium cerate), BaTiO₃ (barium titanate), BaZrO₃ (barium zirconate), and SrTiO₃ (strontium titanate).

7. The oxide superconducting thin film according to claim 1, characterized in that said nanoparticles are nanoparticles generated by using and causing a material which reacts with an organometallic compound to generate nanoparticles to react with said organometallic compound.

8. The oxide superconducting thin film according to claim 7, characterized in that said nanoparticles are nanoparticle formed by reaction between nanoparticles of at least one type of CeO₂ (cerium oxide), ZrO₂ (zirconium dioxide), SiC (silicon carbide), and TiN (titanium nitride) and an organometallic compound contained in a source material solution.

9. A method of manufacturing an oxide superconducting thin film, characterized in that
a predetermined amount of a solution obtained by dissolving nanoparticles functioning as flux pins in a solvent is added to a solution obtained by dissolving an organometallic compound in a solvent to prepare a source material solution for an oxide superconducting thin film, and
said source material solution is used to manufacture an oxide superconducting thin film through a coating-pyrolysis process.

10. A method of manufacturing an oxide superconducting thin film, characterized in that
a predetermined amount of a solution obtained by dissolving nanoparticles reacting with an organometallic compound to generate nanoparticles functioning as flux pins in a solvent is added to a solution obtained by dissolving an organometallic compound in a solvent to prepare a source material solution for an oxide superconducting thin film, and
said source material solution is used to manufacture an oxide superconducting thin film through a coating-pyrolysis process.

11. The method of manufacturing an oxide superconducting thin film according to claim 9, characterized in that a dispersing agent is added to one of said solution obtained by dissolving nanoparticles functioning as flux pins in a solvent and said solution obtained by dissolving nanoparticles reacting with said organometallic compound to generate nanoparticles functioning as flux pins in a solvent.

12. The method of manufacturing an oxide superconducting thin film according to claim 10, characterized in that the solution is prepared taking into account the amount of organometallic compound to be consumed by reaction with the nanoparticles reacting with the organometallic compound to generate nanoparticles functioning as flux pins.

13. The method of manufacturing an oxide superconducting thin film according to claim 10, characterized in that a dispersing agent is added to one of said solution obtained by dissolving nanoparticles functioning as flux pins in a solvent and said solution obtained by dissolving nanoparticles reacting with said organometallic compound to generate nanoparticles functioning as flux pins in a solvent.

14. The method of manufacturing an oxide superconducting thin film according to claim 13, characterized in that the solution is prepared taking into account the amount of organometallic compound to be consumed by reaction with the nanoparticles reacting with the organometallic compound to generate nanoparticles functioning as flux pins.
